(19) United States
(12) Patent Application Publication
(10) Pub. No.: US 2014/0206444 A1
(43) Pub. Date: Jul. 24, 2014

(54) DIGITAL PET SYSTEM AND SOFTWARE PRODUCT

(71) Applicant: FARSTONE TECH. INC., Taipei City (TW)

(72) Inventors: PEI-HU LIN, TAIPEI CITY (TW); KUANG-CHENG LIN, TAIPEI CITY (TW)

(73) Assignee: FARSTONE TECH. INC., Taipei City (TW)

(21) Appl. No.: 13/873,935

(22) Filed: Apr. 30, 2013

(30) Foreign Application Priority Data
Jan. 22, 2013 (TW) 102102383

(51) Int. Cl. A63F 13/00

(52) U.S. Cl. CPC A63F 13/00
USPC 463/31

(57) ABSTRACT

This invention relates to a digital pet software product, which comprises a storage unit and a digital pet program stored in the storage unit. The digital pet program is configured to be installed in a portable electronic device. When the portable electronic device executes the digital pet program, the portable electronic device performs a plurality of operations. The operations comprise generating a digital pet displayed on a display unit of the portable electronic device; and obtaining a geographic position that is variable. The geographic position of the digital pet represents a current position where the digital pet is in a real environment.

### BACKGROUND OF INVENTION

1. Field of Invention

The invention relates to an electronic game system, and more especially to a computer software product of a digital pet or a virtual pet.

2. Related Prior Art

It is well known that people raise pets, take care of pets and play with pets. Pets can give people comfort, ease loneness, and reduce stress. However, it is not convenient to have pets for those who live in congregate housing because of problems such as barking noise, shedding hair, pet droppings, medical issues, and pet bites that raise safety issues. Accordingly, lots of people cannot have pets in their own house due to the above mentioned problems, and thereby cannot benefit from having pets.

In recent years, it is a fad to keep a virtual pet, such as virtual chicken, which allows some owners to enjoy the company of having virtual pets. However, such virtual pets lack a sense of reality, interactivity and so on. Specifically, conventional virtual pet is not like a real pet, which cannot be taken for walks beside the owner, nor interact with other virtual pets. Thus, it is very easy for the owner to lose interests in this conventional type of the virtual pets.

### SUMMARY OF INVENTION

The present invention discloses a digital pet software product. The digital pet program is configured to be installed in a portable electronic device. When the portable electronic device executes the digital pet program, the portable electronic device performs a plurality of operations. The operations comprise generating a digital pet displayed on a display unit of the portable electronic device; and obtaining a variable value of geographic position, such as using a GPS, of the digital pet. The geographic position of the digital pet represents a current position where the digital pet is in a real environment.

Preferably, the operations further comprise providing a walking pet mode. When the portable electronic device stays in the walking pet mode, a value of the geographic position of the digital pet simultaneously varies with changes of the geographic position of the portable electronic device. The variation of the geographic position of the digital pet is equal to the changes of the geographic position of the portable electronic device. The changes of the geographic position of the portable electronic device are obtained by computing location information outputted from a GPS unit of the portable electronic device.

In one embodiment, the operations further comprise providing a map mode. When the portable electronic device stays in the map mode, the display unit shows an electronic map reflective of the real environment, and the electronic map has a pet icon representing the digital pet and an owner icon representing the owner of the portable electronic device. The position of the pet icon on the electronic map indicates the digital pet's current position. The position of owner icon on the electronic map indicates the current position of the portable electronic device. The current position of the portable electronic device is detected by a GPS unit of the portable electronic device.

In one embodiment, the operations further comprise providing a stagnant mode. When the portable electronic device stays in the stagnant mode, a value of the geographic position of the portable electronic device remains unchanged. Besides, the operations further comprise providing a remote monitoring submode under the stagnant mode; wherein when the portable electronic device stays in the remote monitoring submode, the display unit shows an image that the digital pet shows a stagnant movement in a stagnant position.

Besides, the operations further comprise providing a user interactive mode. When the portable electronic device stays in the user interactive mode, the portable electronic device provides several commands and the display unit shows a response action of the digital pet corresponding to the specific command.

The present invention further provides a digital pet system, comprising a server system; and a plurality of portable electronic devices connected to the server system respectively. Each of the portable electronic devices includes a digital pet program installed therein. Each of the portable electronic devices respectively generates a plurality of operations when the digital pet program thereof is executed. The operations of each of the portable electronic devices respectively comprise generating and displaying a digital pet on its own display unit, and uploading information to the server system at a period of time or when portable electronic device location varies. The information comprises a geographic position representing a current position of each of the portable electronic devices and an identification code thereof. The geographic position of each of the portable electronic device is detected by its own GPS unit. The server system computes information uploaded by each of the portable electronic devices to generate a geographic position of the digital pet of each of the portable electronic devices, the server system transfers the geographic position of the digital pet to each of the portable electronic devices, which allows each of the portable electronic devices to change the geographic position of its own digital pet.

Preferably, the operations generated from each of the portable electronic devices further comprise providing a pet interactive mode. When any one of the portable electronic devices stays in the pet interactive mode, a display unit of the portable electronic device shows its own digital pet and other digital pets within a predetermined distance. The digital pets shown on the display unit can interact with each other. The present invention further provides a digital pet system, comprising a server system and at least two portable electronic devices. Each of the two portable electronic devices respectively generates a digital pet and a geographic position of the digital pet. The server system records the geographic position of each of the digital pets, and the server system automatically informs the two portable electronic devices respectively to enter to a pet interactive mode when the geographic position of the two digital pets stays within predetermined distance. For each of the portable electronic devices staying in the pet interactive mode, the display unit of each of the portable electronic devices shows its own digital pet, other digital pet, and their interactions.

Also, the present invention further provides a portable electronic device having a digital pet program installed therein. When the portable electronic device displaying a digital pet and a geographic position of the digital pet when the digital pet program is executed. Furthermore, the present invention further comprises a portable electronic device having a digital pet program installed therein, wherein the digital pet program is capable of allowing the portable electronic device to display interactions between pluralities of digital pets. Each of the digital pets has a geographic position respectively, and digital pets can interact with other digital pets or owners when geographic position of each of the digital pets falls with a predetermined distance.

As mentioned above, the digital pet of the present invention has a geographic position and the value of the geographic position changes when the position of its owner is varied, which enable the digital pet to move with the owner, like a real pet does. Additionally, when the digital pet meets the other digital pet, the digital pet would interact with the other digital pet. In another embodiment, the digital pet would interact with the owner of the other digital pet.

Other features, objects, aspects and advantages will be identified and described in detail below.

### BRIEF DESCRIPTION OF DRAWINGS

FIG. 1 is a block diagram showing a portable electronic device 2 in accordance with an embodiment of the present invention;

FIG. 2 is a view showing the portable electronic device having a display unit that displays a digital pet and its geographic position thereon in accordance with an embodiment of the present invention;

FIG. 3 is a view showing the portable electronic device staying in a map mode in accordance with an embodiment of the present invention;

FIGS. 4A and 4B are views showing that the portable electronic device is switched from the stagnant mode to the map mode in accordance with an embodiment of the present invention;

FIG. 5 is a view showing the portable electronic device staying in a stagnant mode in accordance with an embodiment of the present invention;

FIG. 6 to FIG. 8 are views showing that the portable electronic device stays in a user interactive mode in accordance with an embodiment of the present invention;

FIG. 9 is a block diagram showing a digital pet system in accordance with an embodiment of the present invention;

FIG. 10 is a view showing that the portable electronic device stays in a pet interactive mode in accordance with an embodiment of the present invention; and

FIG. 11 is a view showing that the portable electronic device is switched from the pet interactive mode to a map mode in accordance with an embodiment of the present invention.

### DETAILED DESCRIPTION OF EMBODIMENTS

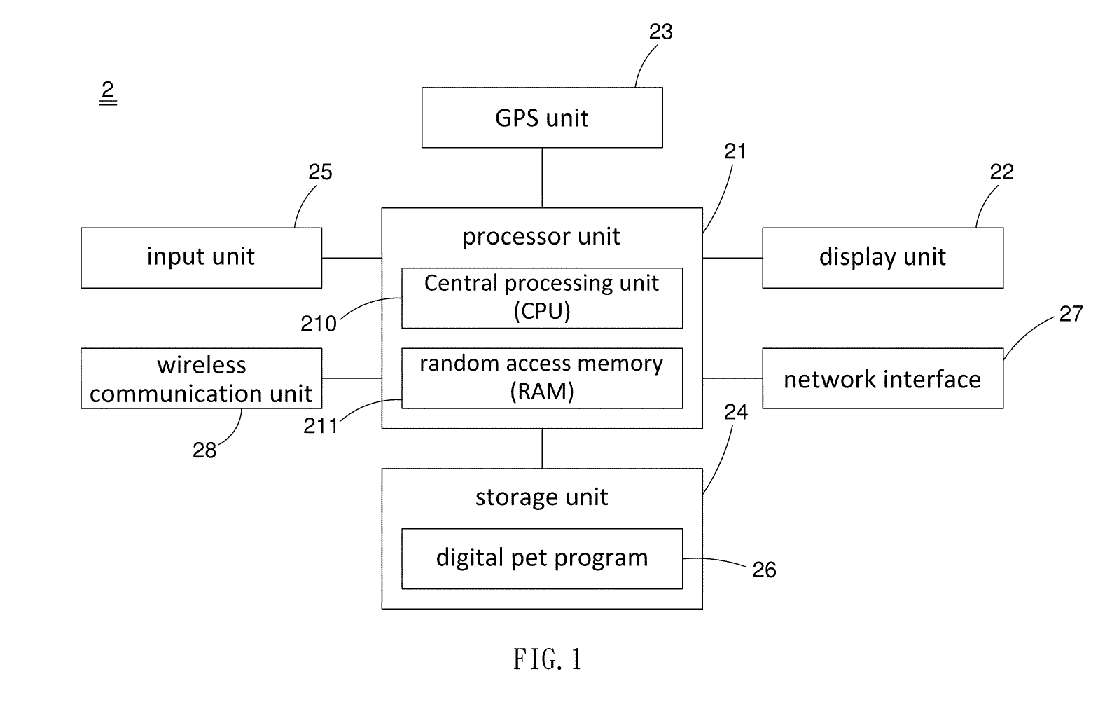

FIG. 1 is a block diagram showing a portable electronic device 2 in accordance with an embodiment of the present invention. The portable electronic device 2 is preferably a smartphone, a tablet computer, or a notebook. For any sake, the portable electronic device 2 comprises a processor unit 21, a display unit 22, a GPS unit 23, a storage unit 24, an input unit 25, a network interface 27 and a wireless communication unit 28. The difference between a conventional portable electronic device and the present invention is that the storage unit 24 includes a digital pet program 26, which would be described hereinafter.

The display unit 22 is preferably a touch screen, or can be a non-touch screen.

The GPS unit 23 can be selected from a commercial GPS chip, such as SiRFstarIV GPS chip from CSR Company, UBX-G6010-ST GPS chip from u-blox Company or other suitable GPS chips. The GPS unit 23 is responsible for receiving a positioning signal sent by a position global positioning system (GPS) and calculating position information, such as time, latitude and longitude coordinates, elevation and so on, according to the positioning signal. Thus, the GPS unit 23 is capable of tracking the geographic position of the portable electronic device 2, representing the current position of the portable electronic device 2 as the portable electronic device 2 is moved. The GPS unit 23 mentioned above can be also selected from a mobile positioning module that is the used of mobile phone base station as a base station.

The storage unit 24 is a storage medium, which can be a non-volatile memory (such as flash memory) or a hard disk. Specifically, the storage unit 24 comprises a digital pet program 24, the other programs not shown in the drawings (such as operation systems and application programs) and information needed for executing the aforementioned programs (not shown in the drawings), which are stored in the storage unit. The digital pet program 26 is first recorded in a computer readable recording medium, for example a disc, flash drive or an access point from the network, and then installed or downloaded from the computer readable recording medium into the storage unit 24.

The input unit 25 comprises a plurality of physical buttons. Preferably, the input unit 25 further comprises touch buttons displayed on the display unit 22. The user can input a command or a data by using the input unit to the processor unit 21 of the portable electronic device 2.

The network interface 27 is used for linking a network, such as the Internet to obtain information on the Internet. Preferably, the network interface 27 is adapted to be linked by a wireless network. As such, user can use the Internet to acquire information, like Google map or geographical data from Geographic Information System (GIS).

The processor unit 21 at least comprises a central processing unit 210 (CPU) and a random access memory 211 (RAM). The digital pet program 26 is initiated first and then its code is downloaded on the random access memory 211 from the storage unit 24, which is executed by the central processing unit 210.

The wireless communication unit 28 is adapted to connect with another wireless communication unit of an electronic device to form a wireless communication connection, which would transmit information to another portable electronic device or receive information from another portable electronic device. The information may be a command or a data. The wireless communication unit 28 is preferably a bluetooth communication module.

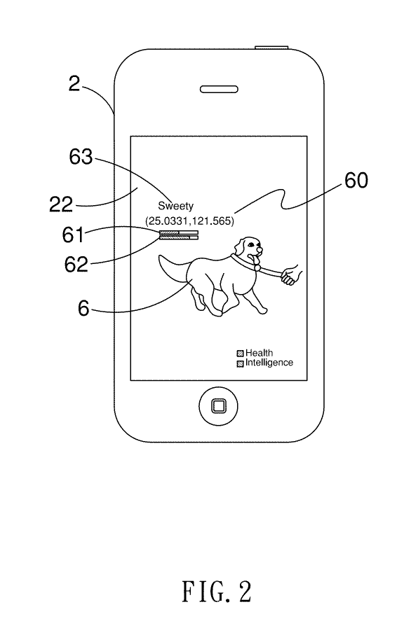

With reference to FIG. 2, when the code of the digital pet program 26 is executed by the processor unit 21, the code would allow the portable electronic device 2 to run some operations. These operations comprises a plurality of steps of generating a digital pet 6 displayed on the display unit 22 and obtaining a geographic position 60 of the digital pet 6. The geographic position represents a current position where the digital pet is in a real environment. Preferably, the operations further comprise steps of displaying the geographic position nearby the digital pet 6. Besides, there might be several digital pets 6 displayed on the display unit 22, which therefore these operations further comprise steps of displaying a name 63 nearby the digital pet 6. The operations further comprise steps of displaying a first scale 61 representing a IQ score of the digital pet 6 and a second scale 62 representing the health condition of the digital pet 6 because each of the pets has different IQ scores and health conditions.

It is noted that the digital pet 6 can be a common image of a real pet, such as a dog, a cat, a bird and so on, such that the feeling that the user observes the digital pet 6 form the display unit 22 is just like a sense of reality that the user observes a real pet through a camera. In addition, the image of digital pet 6 can be obtained from a 2D image or a 3D image of a real pet. Alternatively, the digital pet can be a virtual pet, such as alien extra-terrestrial or dinosaur. The image or photo of the digital pet 6 is stored in the storage unit 24 as an electronic file format.

Preferably, the digital pet 6 includes biomechanical movements, including lying down, rolling over, sitting down, walking, jumping, sleeping, wagging its tail, pricking up its ears, defecating, eating and so on, which is determined by its character attributes. It is known that character attributes of the digital pet 6 and the biomechanical movements that correspond to digital pet's character attributes are set in advance. This means that each digital pet has different character attributes, which also indicates that each digital pet has different personalities and biomechanical movements. Thus, there are different biomechanical movements between different digital pets 6. It is noted that the biomechanical movements, including interactions between real pets and owners or actions from the pets, can be recorded in advance to form several video files. For example, if the digital pet 6 is a Pomeranian dog, the display unit 22 can display the video files of the biomechanical movements of the Pomeranian dog (that are recorded in advance in the storage unit 24). Besides, these operations (not shown in the drawings) further comprise steps of playing barking sounds of the digital pet 6 emitted by a speaker of the portable electronic device 2.

It is noted that the aforementioned images, photos, video files and other information that is needed for executing the digital pets 6 can be established in advance on the Internet database server. The aforementioned information is downloaded on the portable electronic device 2 when executing the digital pet program 26.

The geographic position 60 of the digital pet 6 represents a current position where the digital pet is in a real environment. An original value of the geographic position of the digital pet can be set by the owner of the portable electronic device 2. For example, the original value of the geographic position 60 of the digital pet 6 can be set for the location where the user's home is, or where the current position of portable electronic device 2 is. The original value of the geographic position 60 can be also set automatically for the location where the current position of the portable electronic device 2 is. Preferably, the original value of the geographic position 60 can be automatically set for the location where the current position of the portable electronic device 2 is located a predetermined distance away. For example, the geographic position 60 of the digital pet 6 is located about 1 meter away from the portable electronic device 2. This means that the digital pet 6 is nearby the owner.

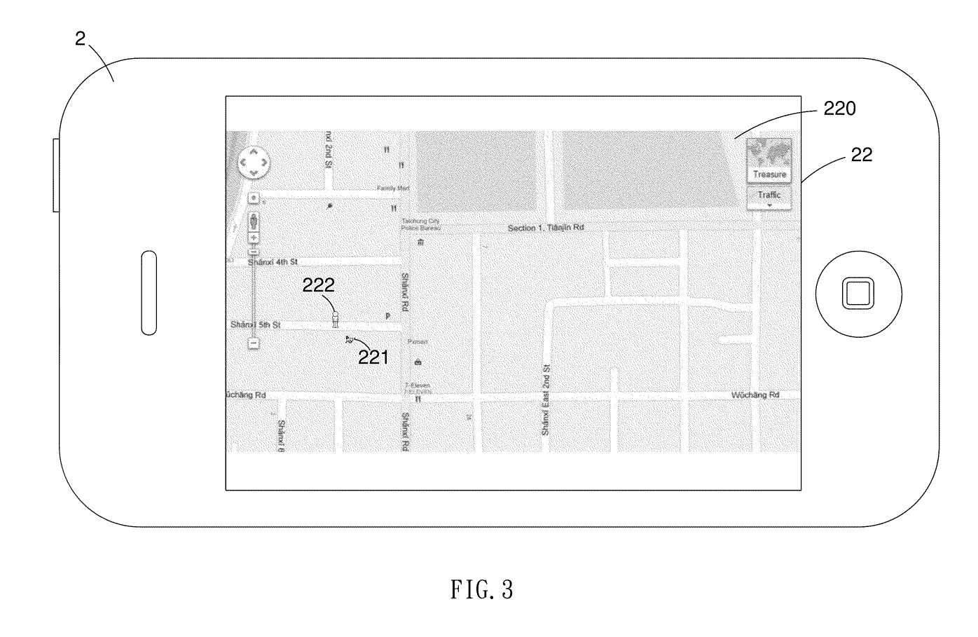

Preferably, the operations further comprise a step of providing a map mode as shown in FIG. 3. When the portable electronic device 2 stays in the map mode, the display unit 22 shows an electronic map 220 reflective of the real environment, and there are a pet icon 221 representing the digital pet 6 and a owner icon 222 representing the owner of the portable electronic device 2 shown on the electronic map 220. Take Google map as an example of the electronic map 220, as shown in FIG. 3, the position of the pet icon 221 on the electronic map 220 indicates the digital pet's current position, which stays in a park that is in front of the Paxmart. The position of owner icon 222 on the electronic map 220 indicates the current position of the portable electronic device 2, which stays in Shanxi 5^{th} St. across the Paxmart. In this example, the digital pet 6 is located only 10 meter apart from the portable electronic device 2, such that both of them can be shown on the electronic map 220 of FIG. 3. However, if the digital pet 6 is located far away from the portable electronic device 2, only one icon, such as the owner icon 222, can be seen on the electronic map 220. The electronic map 220 is needed to be zoomed in to show the pet icon 221 thereon. Preferably, the digital pet 6 can be dynamically displayed on the electronic map 220. As such, the user can see the digital pet 6 and the movement thereof from the electronic map 220, just like see a real pet moving in a real street. In another embodiment, the operations further comprise a step of displaying a distance between the pet icon 221 and the owner icon 222 on the electronic map 220 while staying in the map mode. Therefore, the user knows where the digital pet 6 is and how far it is away from the owner.

In one embodiment, the operations comprise a step of providing a walking pet mode as shown in FIG. 2. When the portable electronic device 2 stays in the walking pet mode, the geographic position 60 of the digital pet 6 has a value that simultaneously varies with changes of the geographic position of the portable electronic device 2, and the variation in the geographic position 60 of the digital pet 6 is equal to the changes of the geographic position of the portable electronic device 2. The changes of the geographic position of the portable electronic device 2 can be obtained by computing location information outputted from a GPS unit 23 of the portable electronic device 2. For example, the original value of the geographic position 60 of the digital pet 6 is set for value A (which might be a value of the current location) and the value of the geographic position of the portable electronic device 2 is set for value B. Specifically, the aforementioned value A, which can be the coordinates of a first point, represents that the digital pet 6 is located in the first point of an east-west street. The value B, which can be the coordinates of a second point, represents that the user carrying the portable electronic device 2 is currently located in the second point of the same east-west street. The distance between the first point and the second point is about 1 meter. When the portable electronic device 2 is moved with the user east for 100 meter that is detected by the GPS unit 23, the processor unit 21 would adjust the value A of the geographic position of the digital pet 6 adjust to a new value that is equal to the value A plus 100 meter east. The distance between the new value and the current location of the portable electronic device 2 is still about 1 meter.

When staying in the walking pet mode, the value of the geographic position 60 of the digital pet 6 simultaneously varies with changes of the geographic position of the portable electronic device 2. Thus, it is apparent that the digital pet 6 substantially moves with the portable electronic device 6, and therefore the user can see the digital pet 6 from the electronic map, which would get a sense of reality just like seeing a real pet following him/her. Accordingly, the user could get a real feeling like walking a real pet.

In one embodiment, when staying in the walking pet mode, the digital pet 6 shows walking movements, such as running, glancing around while running, running and jumping, stop-and-go walking, growling on a walk, pacing and circling, smelling on a walk, dropping on a walk, running away the owner, running toward the owner and so on, which depends on character attributes of the digital pet 6. The aforementioned character attributes of the digital pet 6 and the corresponding walking movements can be established in advance. For example, walking movements, which show that various real pets walk with its owner, can be taped in advance to save several video files of walking movements. If the portable electronic device 2 stays in the walking pet mode and the digital pet 6 is a Pomeranian dog, the display unit 22 thereof can display the video files of the walking movements of the Pomeranian dog (which are recorded in advance in the storage unit 24 thereof or on the Internet database server).

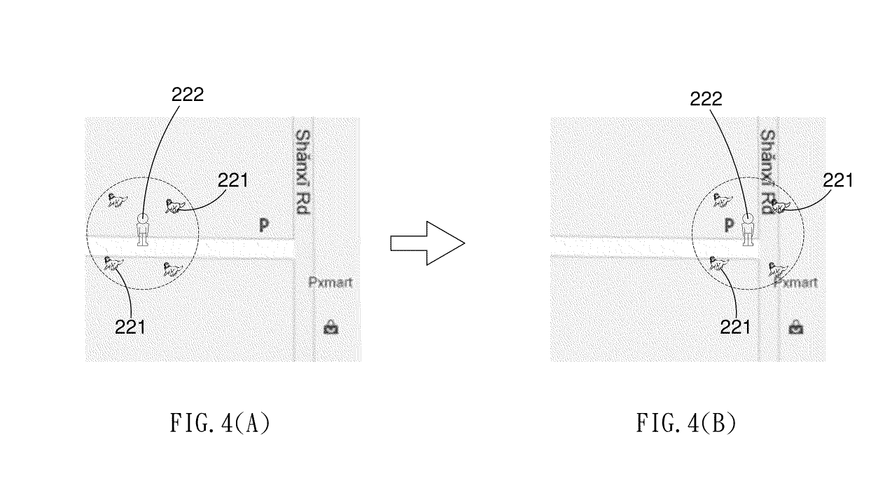

When the digital pet 6 shows the aforementioned biomechanical movements or the walking movements and these movements, such as running or walking, would change its geographic position, the value of the geographic position 60 thereof would be adjusted thereby. It is noted that the value of the geographic position 60 of the digital pet 6 could be adjusted with the movements of the portable electronic device 2, as well as the position changes of the walking movements. Thus, the digital pet 6 seems to walk with the portable electronic device (its owner), and change its location nearby its owner. As shown in FIGS. 4(A) and 4(B), when the user operates the portable electronic device 6 that enable the portable electronic device 6 to stay in the map mode, the pet icon 221 representing the digital pet 6 changes position randomly around the owner icon 222 representing the owner and the pet icon 222 follow the owner icon 222 to move from a first position shown in FIG. 4(A) to a second position shown in FIG. 4(B), which can be seen from the electronic map 220. As such, the user would get a real feeling like a real pet walking around, which means that the user would get a sense of reality just like walking a real dog when seeing the digital pet 6 from the electronic map 220.

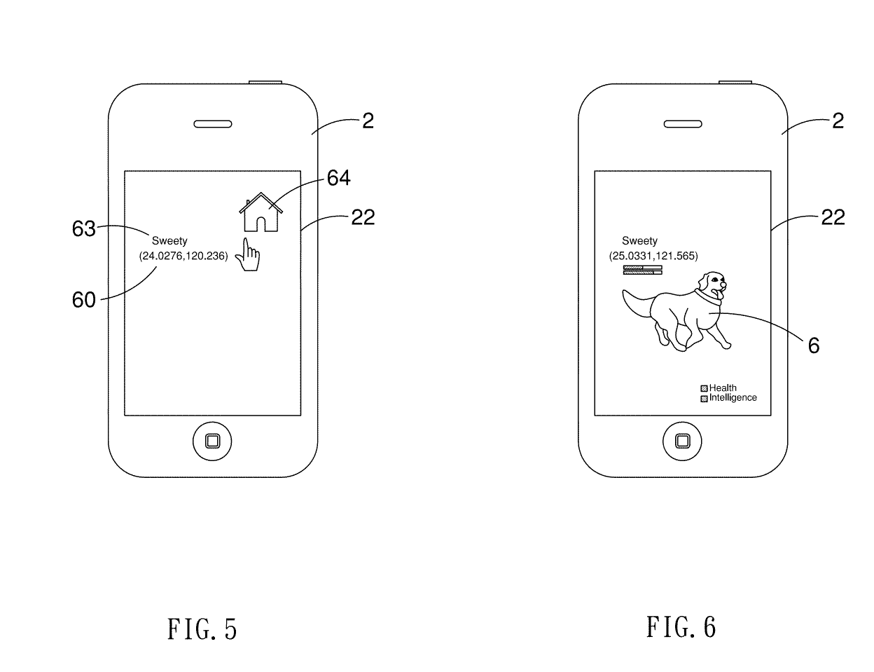

In one embodiment, the operations comprise a step of providing a stagnant mode as shown in FIG. 5. When the portable electronic device 2 stays in the stagnant mode, a value of the geographic position 60 of the digital pet 6 remains unchanged. This means that the digital pet 6 stays in a fixed position (hereinafter called as a stagnant position), which would not move or change its position. Even though the user carries the portable electronic device 2 to move away from the stagnant position, the geographic position 60 of the digital pet 6 would not be changed with the portable electronic device 2. At this situation, a house icon 64 can be displayed on the display unit 22. This shows that the portable electronic device 2 stays in the stagnant mode and the value of the geographic position 60 represents a location where the user set the portable electronic device 2 to the stagnant mode, such as the user's home. If the portable electronic device 2 is switched to the aforementioned map mode after the user moves away from the stagnant position, the pet icon 221 would stay in a position and the owner icon 222 would stay in another position away from the pet icon 221.

In another embodiment, the operations further comprise a step of providing a remote monitoring submode under the stagnant mode. This means that icon 64 shown in FIG. 5 is used as a touch icon. When the icon 64 is touched, the portable electronic device 2 enters the remote monitoring submode. At this situation, the display unit 22 shows an image that the digital pet 6 shows stagnant movements in the stagnant position, such as circling in the house, eating food, sleeping, biting and so on, depending on character attributes of the digital pet 6. It is known that character attributes of the digital pet 6 and the corresponding stagnant movements can be set in advance. For example, stagnant movements that various real pets exhibit in a house can be taped in advance to save several video files of stagnant movements. If the portable electronic device 2 stays in the remote monitoring submode and the digital pet 6 is a Pomeranian dog, the display unit 22 thereof can display the video files of the stagnant movements of the Pomeranian dog (which are saved in the storage unit 24 thereof in advance or on the Internet database server). Therefore, the user far away from the digital pet 6 (such as in the office) can monitor the digital pet 6 that stays in the house.

In one embodiment, the operations further comprises steps of displaying an image of a real pet that represents the digital pet 6 on the display unit 22 when a distance between the geographic position of the portable electronic device 2 and the geographic position 60 of the digital pet 6 is less than a predetermined value (such as 20 meter); and displaying a icon representing the digital pet 6 or aforementioned map mode on the display unit 22 when a distance between the geographic position of the portable electronic device 2 and the geographic position 60 of the digital pet 6 is greater than the predetermined value. Accordingly, the user could understand that he/she stays a distance away from the digital pet 6.

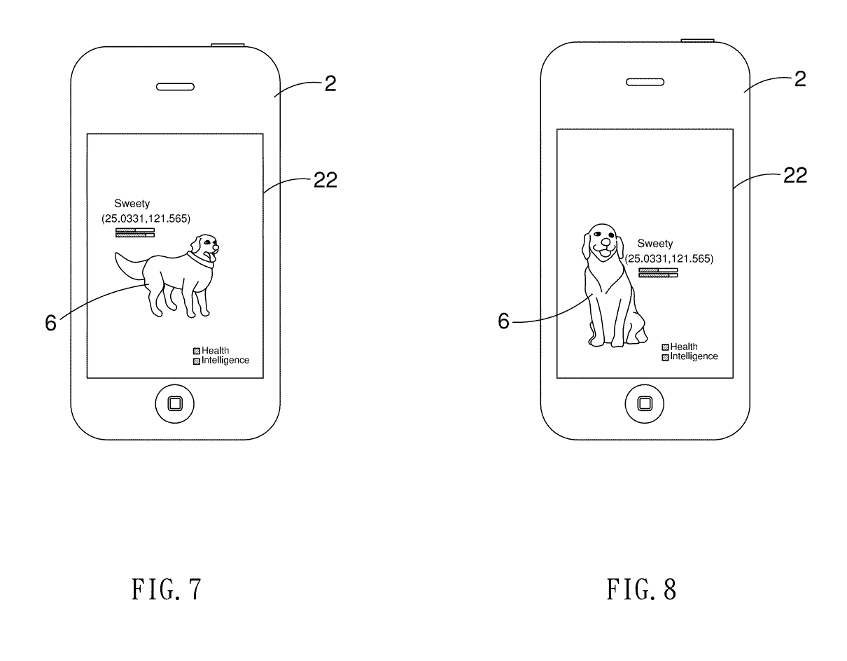

In one embodiment, the operations further comprise a step of providing a user interactive mode. When the portable electronic device 2 stays in the user interactive mode, the portable electronic device 2 provides several commands and the display unit 22 shows a response action of the digital pet 6 corresponding to the executed command when one of the commands is executed. For example, when the user says “Come, Sweety” to the portable electronic device 2, which means that a voice command is executed, the digital pet 6 would run to the user, as shown in FIG. 6. Besides, voice commands, such as sit, shake hands, lie down and so on can be set in advance in the portable electronic device 2. In addition, these voice commands that relate to touch-gestures can be set in advance as well. For example, the user can make different finger gestures on the display unit 22 to execute different commands, such as dragging on the display from top to bottom with a finger to activate the command “sit”, dragging from bottom to top with a finger to activate the command “stand up”, tapping the digital pet's feet twice with a finger on the display unit 22 to activate the command “shake hands”, swiping at the digital pet's back, head or belly back and forth to activate command “stroke” and so on.

As shown in FIG. 7, the digital pet 6 exhibits the “stand” position, which would correspond to a “stand” command. As shown in FIG. 8, the digital pet 6 exhibits the “sit” position, which would correspond to a “sit” command. The aforementioned commands can be used to enable the digital pet 6 to do some specific actions, or to train the digital pet 6 to react. As shown in FIG. 7, when dragging from top to bottom with a finger, it is a training command “sit”. If intelligence of the digital pet 6 is high, which means the digital pet 6 learn fast, the digital pet 6 needs only few times of training to learn well. On the contrary, if the digital pet 6 get low IQ, which means it might need several times of training to learn it well. In other words, the speed and accuracy of the digital pet 6 reaction depend on its IQ and training times. When the digital pet 6 can react quickly and exactly on training commands, the training commands can be establish as basic commands.

The user can instruct and train the digital pet 6 by the user interactive mode mentioned above, which might have fun on the training process, just like training a real one.

Besides, when the portable electronic device 2 is operated under a feeding mode, the user can feed the digital pet 6. It is known that the physical growth and character of the digital pet 6 would be different at various development stages, as well as its IQ level and health condition level would be different.

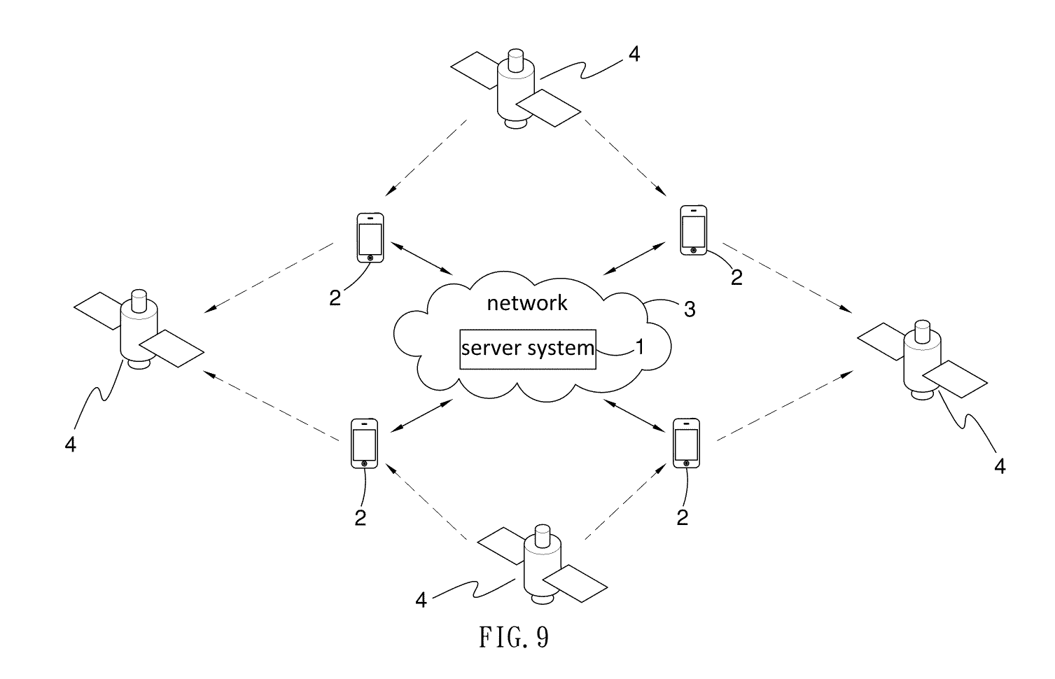

FIG. 9 is a block diagram showing a digital pet system in accordance with an embodiment of the present invention. With reference to FIG. 9, the digital pet system comprises a server system 1 and a plurality of the portable electronic devices 2. The server system 1 consists of one or several server computers and corresponding software and hardware. Each of the portable electronic devices 2 has circuit framework that is substantially equal to that of the portable electronic devices 2. In this system, each of the portable electronic devices 2 links to server system 1 by its own network interface through the Internet, such that each of the portable electronic devices 2 can transmit commands or information to the server system 1. Also, each of the portable electronic devices 2 communicates with GPS satellite 4 by its own GPS unit to get the geographic position for the current location. The most important thing is that each of the portable electronic devices 2 comprises its own digital pet system.

When each of the portable electronic devices 2 activates its own digital pet system, each of the portable electronic devices 2 would generate a plurality of operations. The operations comprises those operations generated by the portable electronic device 2 mentioned above and a step of uploading information to the server system 1 at a period of time (or at every certain period of time, for example) or when portable electronic device 2 location varies. The information at least comprises a geographic position representing a current position of each of the portable electronic devices 2 and an identification code thereof (such as International Mobile Equipment Identity number; IMEI). After the server system 1 computes information uploaded by each of the portable electronic devices 2 to generate a geographic position of the digital pet for each of the portable electronic devices 2, the server system 1 transfers the geographic position of the digital pet to each of the portable electronic devices 2, which allows the value of the geographic position of the digital pet to be changed from each of the portable electronic devices 2.

The server system 1 further comprises digital pet information stored therein. Information of each of the digital pets comprises, but not limited to, identification code, types, names, ages, IQ levels, health condition levels, adoption, adopter information, adopt date, position, pet food, character, various image files or video files stored in advance and etc, which are listed as below.

| Identification | | | Age | | | |
|---|---|---|---|---|---|---|
| Code | Type | Name | (Month) | IQ | Health | Adoption |
| A001 | Labrador | Sweety | 2 | 85 | 90 | YES |
| | Retriever | | | | | |
| A002 | Persian cat | Cathy | 1 | 80 | 85 | YES |
| A003 | Dachshund | — | 6 | 75 | 92 | No |
| A004 | macaw | Tina | 15 | 95 | 93 | YES |
| A005 | mixed-breed | Afu | 39 | 95 | 90 | YES |
| | dog | | | | | |
| . . . | . . . | . . . | | . . . | . . . | . . . |

The “type” information is directed to a species of the digital pet. Various digital pets have different IQ level. A starting value of the IQ level can be established according to IQ level of real pets, and the value of the IQ level would vary with age and training times executed the aforementioned training commands. The “health” information is directed to health condition of the digital pet, which value would vary with corresponding operations of the system of the present invention. The “name” information is directed to a name of the digital pet, which can be named by its adopter. The “adoption” information is used to show whether the digital pet is adopted by an adopter or not. The “position” information is directed to a geographic position representing a current position of the digital pet, which can be shown as, but not limited to, time/longitude and latitude. The “pet food” information is directed to a virtual food that a digital pet needs (including principle food, snacks, vegetables, medicine and so on) and amount of the food. The virtual food can be bought from a shopping website with virtual coins by using server system 1. The “various image files or video files stored in advance” information is directed to image files or video files showing the digital pet walks, runs, sits, lies down, stands, smells, barks, being affectionate, acts wildly, and so on, which are taped from real pets.

The owner of each of the portable electronic devices 2 can fill adopter's information in an application website from the server system 1 (which means the user's name and contact information), and choose a digital pet that he/she wants to adopt, and operate other processes, so as to complete an adoption process of a digital pet. Preferably, the adoption process further comprises a payment step to charge the adopter certain fees.

Once the adoption process is finished by each of the portable electronic devices 2, the server system 1 would record its information, such as IMEI code of each of the portable electronic devices 2, the identification code and names for the adopted digital pet (named by the owners of each of the portable electronic devices 2), geographic position when adopted, and so on. The information of the digital pet, such as character attributes, ages, identification code, health condition, IQ level, geographic position (starting value), name, image files and video files of the digital pet that is adopted and so on, can be downloaded from the server system 1 on each of the portable electronic devices 2. At this time, the user of each of the portable electronic device 2 has to activate their own digital pet system to see the digital pet that he/she adopted from the display unit and perform some operations, such as the aforementioned modes.

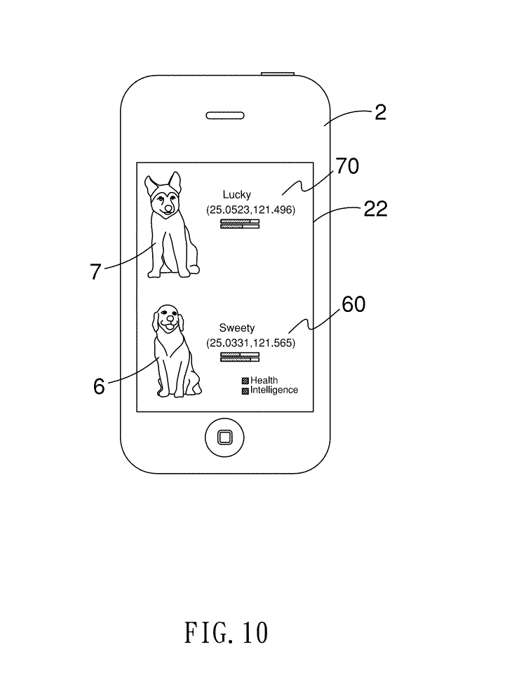

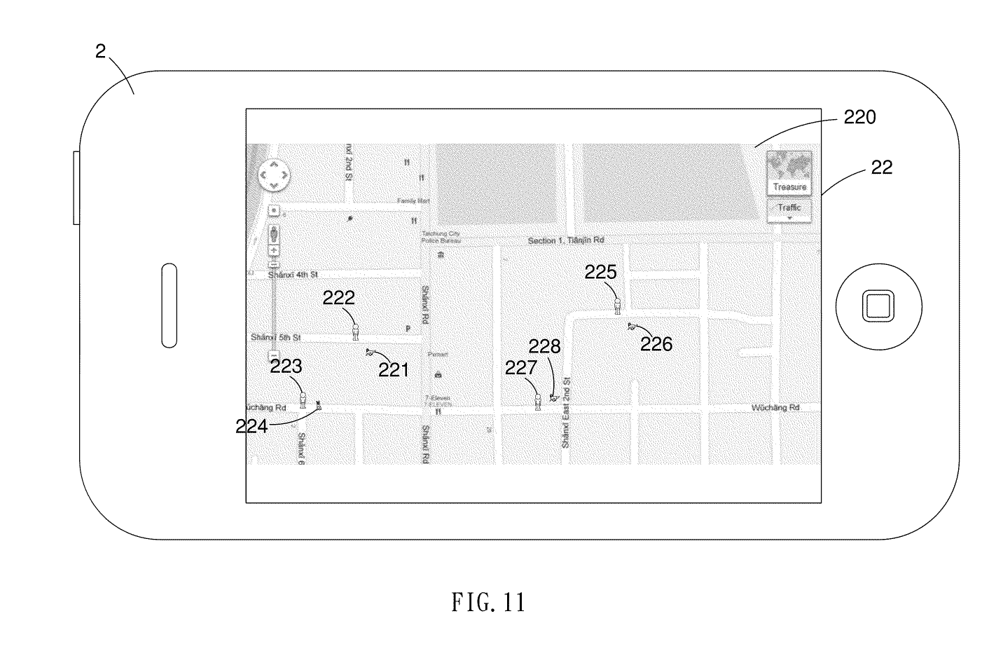

The operations generated by each of the portable electronic devices 2 further comprise a step of providing a pet interactive mode. When each of the portable electronic devices 2 stays in the interactive mode, the display unit 33 of each of the portable electronic devices 2 would display its own digital pet 6, the other digital pet 7 around the digital pet 6, and geographic positions 60, 70 belong to themselves respectively, as shown in FIG. 10 (there is one other digital pet 7 displayed as an example in FIG. 10). If any one of the portable electronic devices 2 is switched to the map mode mentioned above, as shown in FIG. 11, the display unit 22 shows an electronic map 220 and several icons, including owner icons 222, 223, 225 227 and pet icons 221, 224, 226, 228, wherein each icon respectively represents the user of each of the portable electronic devices 2 and digital pet that he or she adopted. As such, the owner of each of the portable electronic devices 2 can see their own digital pet and the other digital pets within a predetermined distance. Preferably, when these digital pets are close to each other, the digital pets shown on the display unit 22 of each of the portable electronic devices 2 interact with each other, such as sniffing each other, fighting, barking, growling, howling and other interaction, which is determined by its character attributes. It is noted that character attributes of these digital pets and the interactions can be established in advance. For example, the motions that several real pets meet with each other can be recorded in advance to form several video files of pet interactions. If the digital pets are a Pomeranian dog and a Labrador Retriever dog, the display unit would display the video files of interactions between the Pomeranian dog and the Labrador Retriever dog (that is recorded in the server system 1 in advance) when any one of the portable electronic device 2 stays in the pet interactive mode.

According to the above description, the server system 1 includes the records of geographic positions of all of the portable electronic devices 2 representing the current location of each of the portable electronic devices and geographic positions of the digital pets thereof. Thus, the server system 1 can automatically inform each of the portable electronic devices 2 of information, which allows each of the portable electronic devices 2 to display the digital pet nearby for user to choose. Once, a digital pet nearby the portable electronic device belonging to the user has been chosen, each of the portable electronic devices 2 can communicate with the portable electronic device 2 having the digital pet that is chosen through the server system 1, which thereby the two or more of the digital pets can interact with each other. Alternatively, the server system 1 can automatically inform each of the portable electronic devices 2 under a certain condition, which allows each of the portable electronic devices 2 to automatically switch to the aforementioned pet interactive mode based on the command received by them respectively. At this situation, each of the portable electronic devices 2 can communicate with the other portable electronic device 2 through the server system 1, and the display unit of each of the portable electronic devices 2 displays the two or more of the digital pets interacting with each other. For example, when there are two digital pet (or more than two) within a distance of 100 meter between them computed by the server system 1 (which means that the above condition is set up), the server system 1 would automatically inform the two portable electronic devices respectively having the two digital pets of the command (or information) to enable the display units of the two portable electronic devices display the two digital pets interacting with each other.

In the system of the present invention, if there are several users who operate their own portable electronic device while walking on a place, they can see their own digital pet interacting with other digital pets when any one of them switch their portable electronic devices to a pet interactive mode. Accordingly, each of the users can get a real feeling like seeing real pets interacting with each other.

In one embodiment, when the code of the aforementioned digital pet program 26 is executed by the processor unit 21, the code would allow the portable electronic device 2 to run some operations. These operations comprise a plurality of steps of providing pet interactive mode. When the portable electronic device 2 stays in the pet interactive mode, the processor unit 21 drives the wireless communication unit 28 to execute a search procedure and drives the display unit 22 to display its own digital pet 6 and other digital pet of another portable electronic device after finding other digital pet of another portable electronic device. For example, there are one or more than one portable electronic devices, and the aforementioned digital pet program 26 has been installed in these portable electronic devices respectively, wherein each of the portable electronic devices has its own digital pet and has been set for a condition of being detected. If any one of the portable electronic devices is detected nearby the portable electronic device 2, the display unit 22 of the portable electronic device 2 would display the digital pets that have been detected for him or her selection. If the other portable electronic devices are switched to the pet interactive mode mentioned above, then the display unit thereof would show its own digital pet and the other digital pets nearby (including the digital pet 6). The wireless communication unit of the portable electronic devices, whose digital pets have been selected, would wireless communicate with the portable electronic device 2. As this situation, both of the display units thereof would show its own digital pet and the other digital pet (which may further include geographic positions thereof and their owners' name). Even more, both of the two users can display communicate with each other by typing text, sending images and voice files through an instant communication interface as well. Besides, both of the two digital pets shown on the display units would display interaction with each other, which is illustrated above.

Compared with the prior digital pet devices, the digital pets of the present invention can move with the owner, interact with the owner, other digital pets, or other digital pets' owners, just like a real pet can. Accordingly, the users could get a real feeling like raising a real pet, and thereby get benefits and have pleasure of owning a pet.

It will be appreciated that although a particular embodiment of the invention has been shown and described, modifications may be made. It is intended in the claims to cover such modifications which come within the spirit and scope of the invention.

The invention claimed is:

1. A digital pet software product comprising:
a storage medium; and
a digital pet program, stored in the storage medium, wherein the digital pet program is installed in a portable electronic device and is executed by a processor unit of the portable electronic device which allows the portable electronic device to perform a plurality of operations comprising:
generating and displaying a digital pet on a display unit of the portable electronic device; and
obtaining a geographic position of the digital pet, the geographic position representing a current position where the digital pet is in a real environment.

2. The digital pet software product of claim 1, wherein the operations further comprise providing a walking pet mode, wherein when the portable electronic device stays in the walking pet mode, a value of the geographic position of the digital pet simultaneously varies with changes of the geographic position of the portable electronic device; a variation of the geographic position of the digital pet is equal to the changes of the geographic position of the portable electronic device; and the changes of the geographic position of the portable electronic device is obtained by computing a location information outputted from a GPS unit of the portable electronic device.

3. The digital pet software product of claim 1, wherein the operations further comprise providing a map mode, wherein when the portable electronic device stays in the map mode, the display unit shows an electronic map reflective of the real environment, and the electronic map has a pet icon representing the digital pet and a owner icon representing the owner of the portable electronic device thereon; the position of the pet icon on the electronic map indicates the digital pet's current position; the position of owner icon on the electronic map indicates the current position of the portable electronic device; and the current position of the portable electronic device is detected by a GPS unit of the portable electronic device.

4. The digital pet software product of claim 2, wherein the operations further comprise providing a stagnant mode, wherein when the portable electronic device stays in the stagnant mode, the value of the geographic position of the digital pet remains unchanged.

5. The digital pet software product of claim 4, wherein the operations further comprise providing a remote monitoring submode under the stagnant mode; wherein when the portable electronic device stays in the remote monitoring submode, the display, unit shows an image of the digital pet in a stagnant position.

6. The digital pet software product of claim 1, wherein the operations further comprise providing a user interactive mode, wherein when the portable electronic device stays in the user interactive mode, the portable electronic device provides several commands and the display unit shows a response action of the digital pet corresponding to the executed command when one of the commands is executed.

7. A digital pet system comprising:
a server system; and
a plurality of portable electronic devices, connected to the server system respectively and each of the portable electronic devices including a digital pet program installed therein;
wherein each of the portable electronic devices respectively generates a plurality of operations when the digital pet program thereof is executed; the operations thereof respectively comprise generating and displaying a digital pet on its own display unit, and uploading information to the server system at a period of time; wherein the information comprises a geographic position representing a current position of each of the portable electronic devices and an identification code thereof; wherein the geographic position of each of the portable electronic device is detected by a GPS unit of each of the portable electronic devices; wherein after the server system computes information uploaded by each of the portable electronic devices to generate a geographic position of the digital pet of each of the portable electronic devices, the server system transfers the geographic position of the digital pet to each of the portable electronic devices, which allows each of the portable electronic devices to change the geographic position of its own digital pet.

8. The digital pet system of claim 7, wherein the operations of uploading information to the server system is performed when portable electronic device location varies.

9. The digital pet system of claim 7, wherein the operations generated from each of the portable electronic devices further comprise providing a pet interactive mode; when one of the portable electronic devices stays in the pet interactive mode, a display unit of the portable electronic device shows its own digital pet and other digital pets within a predetermined distance.

10. The digital pet system of claim 9, wherein the digital pets shown on the display unit interact with each other.

11. The digital pet system of claim 9, wherein the digital pets shown on the display unit interact with other digital pets' owners.

12. A digital pet system, comprising a server system and at least two portable electronic devices, each of the two portable electronic devices respectively generating a digital pet and a geographic position of the digital pet, the server system recording the geographic position of each of the digital pets, the server system automatically informing the two portable electronic devices respectively to enter pet interactive mode when the geographic position of the two digital pets stays within a predetermined distance, wherein each of the portable electronic devices stays in the pet interactive mode, the display unit of each of the portable electronic devices shows its digital pet and the other digital pet and the two digital pets can interact.
